(19) United States
(12) Patent Application Publication
(10) Pub. No.: US 2024/0337755 A1
(43) Pub. Date: Oct. 10, 2024

(54) PRECISE POSITIONING ENGINE (PPE) BASE STATION SWAP HANDLING

(71) Applicant: QUALCOMM Incorporated, San Diego, CA (US)

(72) Inventors: Min WANG, Tustin, CA (US); Ning LUO, Cupertino, CA (US); Yinghua YANG, San Jose, CA (US); James STEPHEN, Lake Forest, CA (US); Han ZHANG, Beijing (CN); Yuxiang PENG, Sunnyvale, CA (US); Satya Swaroop YADATI, Bangalore, Karnataka (IN); Anupam KUMAR, New Delhi (IN)

(21) Appl. No.: 18/293,347

(22) PCT Filed: Apr. 7, 2022
(86) PCT No.: PCT/CN2022/085476

§ 371 Date: Jan. 29, 2024

(30) Foreign Application Priority Data
Sep. 28, 2021 (IN) 202121044024

(51) Int. Cl. G01S 19/07

(52) U.S. Cl. CPC G01S 19/07

(57) ABSTRACT

A Precise Positioning Engine (PPE) may use correction information to perform highly accurate Global Navigation Satellite Systems (GNSS) positioning. Transitioning between, or “swapping,” of a first correction information source (e.g., Real-Time Kinematic (RTK) base station) with a second correction information source may be handled using correction information from the first correction information source to update a first state of the PPE. The updated PPE can then be modified by initializing at least ambiguity values of the PPE state. Correction information from the second base can be used to further update the PPE to a second state without a time update at the PPE. By employing this process, embodiments can reduce sudden changes in position estimation due to correction information source swapping, which can often result in resetting of the PPE and a reduced user experience quality.

### BACKGROUND

### 1. Field of Disclosure

The present disclosure relates generally to the field of satellite-based positioning.

### 2. Description of Related Art

Global Navigation Satellite Systems (GNSS) positioning of mobile devices (e.g., consumer electronics, vehicles, assets, drones, etc.) can provide accurate positioning of a mobile device comprising a GNSS receiver. Traditional GNSS positioning provides an accuracy on the order of a few meters, and more precise GNSS-based techniques can provide sub-meter accuracy. These more precise GNSS-based techniques, which include Real-Time Kinematic (RTK) positioning and Precise Point Positioning (PPP), may be implemented using a Precise Positioning Engine (PPE) at the mobile device.

To implement these more precise GNSS-based techniques, a mobile device may need to obtain correction information from a correction information source, such as a virtual or physical base station. Because correction information from a base station is applicable to a particular geographical area, multiple base stations may be networked together to provide coverage for a larger region such that the larger region may be divided into different geographical areas corresponding to different base stations. Thus, for a mobile device moving from one of these geographical areas to another, the mobile device may need to “swap” base stations, transitioning from receiving correction information from one base station to another.

### BRIEF SUMMARY

Embodiments described herein provide for handling swapping of a first base station with a second base station by utilizing correction information from each base station. In particular, correction information from the first base station can be used to update the PPE. The resulting PPE state can then be modified by initializing at least the ambiguity values of the PPE state. Subsequently, the PPE can be further updated, based on correction information from the second base station. This further update can be done without a time update at the PPE. By employing this process, embodiments can reduce sudden changes in position estimation due to base station swapping, which can often result in resetting of the PPE and a reduced user experience quality.

An example method of handling a correction information source change for Global Navigation Satellite System (GNSS) positioning of a mobile device, according to this disclosure, may comprise obtaining first correction information from a first correction information source and second correction information from a second correction information source. The method also may comprise updating a Precise Positioning Engine (PPE) implemented at the mobile device to generate a first PPE state, wherein: the first PPE state comprises a first set of position values, velocity values, and ambiguity values related to the position of the mobile device, and the first PPE state is based at least in part on the first correction information and a set of measurements obtained from data received by a GNSS receiver of the mobile device. The method also may comprise modifying the first PPE state by initializing at least the ambiguity values of the first PPE state. The method also may comprise updating the modified first PPE state to generate a second PPE state, wherein: the second PPE state comprises a second set of position values, velocity values, and ambiguity values related to the position of the mobile device, and the second PPE state is based at least in part on the second correction information and the set of measurements obtained from data received by the GNSS receiver of the mobile device.

An example mobile device for handling a correction information source change for Global Navigation Satellite System (GNSS) positioning of a mobile device, according to this disclosure, may comprise a GNSS receiver, a memory, one or more processors communicatively coupled with the GNSS receiver and the memory, wherein the one or more processors are configured to obtain first correction information from a first correction information source and second correction information from a second correction information source. The one or more processors further may be configured to update a Precise Positioning Engine (PPE) implemented at the mobile device to generate a first PPE state, wherein: the first PPE state comprises a first set of position values, velocity values, and ambiguity values related to the position of the mobile device, and the first PPE state is based at least in part on the first correction information and a set of measurements obtained from data received by the GNSS receiver of the mobile device. The one or more processors further may be configured to modify the first PPE state by initializing at least the ambiguity values of the first PPE state. The one or more processors further may be configured to update the modified first PPE state to generate a second PPE state, wherein: the second PPE state comprises a second set of position values, velocity values, and ambiguity values related to the position of the mobile device, and the second PPE state is based at least in part on the second correction information and the set of measurements obtained from data received by the GNSS receiver of the mobile device.

An example apparatus for handling a correction information source change for Global Navigation Satellite System (GNSS) positioning of a mobile device, according to this disclosure, may comprise means for obtaining first correction information from a first correction information source and second correction information from a second correction information source. The apparatus further may comprise means for updating a Precise Positioning Engine (PPE) implemented at the mobile device to generate a first PPE state, wherein: the first PPE state comprises a first set of position values, velocity values, and ambiguity values related to the position of the mobile device, and the first PPE state is based at least in part on the first correction information and a set of measurements obtained from data received by a GNSS receiver of the mobile device. The apparatus further may comprise means for modifying the first PPE state by initializing at least the ambiguity values of the first PPE state. The apparatus further may comprise means for updating the modified first PPE state to generate a second PPE state, wherein: the second PPE state comprises a second set of position values, velocity values, and ambiguity values related to the position of the mobile device, and the second PPE state is based at least in part on the second correction information and the set of measurements obtained from data received by the GNSS receiver of the mobile device.

According to this disclosure, an example non-transitory computer-readable medium stores instructions for handling a correction information source change for Global Navigation Satellite System (GNSS) positioning of a mobile device, the instructions comprising code for obtaining first correction information from a first correction information source and second correction information from a second correction information source. The instructions further may comprise code for updating a Precise Positioning Engine (PPE) implemented at the mobile device to generate a first PPE state, wherein: the first PPE state comprises a first set of position values, velocity values, and ambiguity values related to the position of the mobile device, and the first PPE state is based at least in part on the first correction information and a set of measurements obtained from data received by a GNSS receiver of the mobile device. The instructions further may comprise code for modifying the first PPE state by initializing at least the ambiguity values of the first PPE state. The instructions further may comprise code for updating the modified first PPE state to generate a second PPE state, wherein: the second PPE state comprises a second set of position values, velocity values, and ambiguity values related to the position of the mobile device, and the second PPE state is based at least in part on the second correction information and the set of measurements obtained from data received by the GNSS receiver of the mobile device.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified diagram of a Global Navigation Satellite System (GNSS) system, according to an embodiment.

FIG. 2 is a simplified diagram of an embodiment of a Real-Time Kinematic (RTK) system.

FIG. 3 is a diagram illustrating a scenario in which a rover, or mobile device, may swap from a first base station 320 to a second base station 330.

FIG. 4 is a block diagram illustrating how a Precise Positioning Engine (PPE) may utilize various data to generate an updated PPE state when switching between base stations (or correction information sources), according to an embodiment.

FIG. 5 is a flow diagram illustrating an embodiment of a method of handling a correction information source change for GNSS positioning of a mobile device.

FIGS. 6A-10 are a series of tables illustrating values for correction data and PPE states used in an example transition of a mobile device from a first correction information source to a second correction information source, according to an embodiment.

FIGS. 11A-11C are graphs that plot simulated values for horizontal error (HE) and HE uncertainty over time using different techniques for handling correction information source (base station) swapping.

FIG. 12 is a block diagram of various hardware and software components of a mobile device, according to an embodiment.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used, and various modifications may be made without departing from the scope of the disclosure or the spirit of the appended claims.

As described herein, a satellite receiver, such as a Global Navigation Satellite Systems (GNSS) receiver, may be integrated into a mobile device comprising an electronic device or system. Such a mobile device can include, for example, consumer, industrial, and/or commercial electronics, vehicles, assets, vessels, and the like. As described herein, a location estimate of the satellite receiver or mobile device into which the satellite receiver is integrated may be referred to as a location, location estimate, location fix, fix, position, position estimate, or position fix of the satellite receiver or mobile device. Moreover, the location estimate may be geodetic, thus providing location coordinates for the mobile device (e.g., latitude and longitude) which may or may not include an altitude component (e.g., height above sea level, height above or depth below ground level, floor level, or basement level). In some embodiments, a location of the satellite receiver and/or mobile device comprising the satellite receiver may also be expressed as an area or volume (defined either geodetically or in civic form) within which the satellite receiver is expected to be located with some probability or confidence level (e.g., 68%, 95%, etc.). In the description contained herein, the use of the term location may comprise any of these variants unless indicated otherwise. When computing the location of a satellite receiver, such computations may solve for local X, Y, and possibly Z coordinates and then, if needed, convert the coordinates from one coordinate frame to another.

As noted, embodiments described herein provide for handling swapping of a first base station with a second base station by utilizing correction information from each base station. In particular, correction information from the first base station can be used to update the PPE. The resulting PPE state can then be modified by initializing at least the ambiguity values of the PPE state. Subsequently, the PPE can be further updated, based on correction information from the second base station. Additional details will follow after an initial description of relevant systems and technologies.

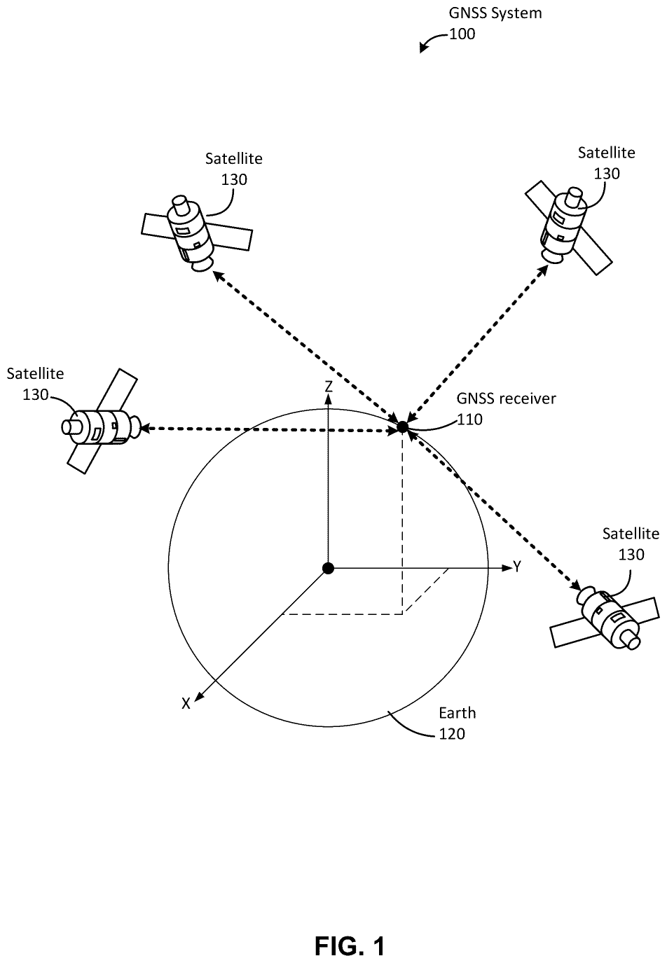

FIG. 1 is a simplified diagram of a GNSS system 100, provided to illustrate how GNSS is generally used to determine an accurate location of a GNSS receiver 110 on earth 120 (also known as “positioning” of the GNSS receiver). Put generally, the GNSS system 100 enables an accurate GNSS position fix of the GNSS receiver 110, which receives radio frequency (RF) signals from GNSS satellites 130 from one or more GNSS constellations. (A satellite such as GNSS satellites 130 may also be referred to as a space vehicle (SV).) The type of device utilizing a GNSS receiver 110 may vary, depending on application. In some embodiments, for instance, such a device may comprise consumer electronics or devices, such as a mobile phone, tablet, laptop, wearable device, vehicle (or on-vehicle device), or the like. In some embodiments, the GNSS receiver 110 may be integrated into industrial or commercial equipment, such as survey equipment.

It will be understood that the diagram provided in FIG. 1 is greatly simplified. In practice, there may be dozens of satellites 130 and a given GNSS constellation, and there are many different types of GNSS systems. GNSS systems include, for example, Global Positioning System (GPS), Galileo (GAL), Global Navigation Satellite System (GLONASS), Quasi-Zenith Satellite System (QZSS) over Japan, Indian Regional Navigational Satellite System (IRNSS) over India, BeiDou Navigation Satellite System (BDS) over China, and/or the like. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is based on trilateration, which is a method of determining position by measuring distances to points at known coordinates. In general, the determination of the position of a GNSS receiver 110 in three dimensions may rely on a determination of the distance between the GNSS receiver 110 and four or more satellites 130. As illustrated, 3D coordinates may be based on a coordinate system (e.g., XYZ coordinates; latitude, longitude, and altitude; etc.) centered at the earth's center of mass. A distance between each satellite 130 and the GNSS receiver 110 may be determined using precise measurements made by the GNSS receiver 110 of a difference in time from when a radio frequency (RF) signal is transmitted from the respective satellite 130 and when it is received at the GNSS receiver 110. To help ensure accuracy, not only does the GNSS receiver 110 need to make an accurate determination of when the respective signal from each satellite 130 is received, but many additional factors need to be considered and accounted for. These factors include, for example, clock differences at the GNSS receiver 110 and satellite 130 (e.g., clock bias), a precise location of each satellite 130 at the time of transmission (e.g., as determined by the broadcast ephemeris), the impact of atmospheric distortion (e.g., ionospheric and tropospheric delays), and the like.

To perform a traditional GNSS position fix, a positioning engine at the GNSS receiver 110 can use code-based positioning to determine its distance to each satellite 130 based on a determined delay in a generated pseudorandom binary sequence received in the RF signals received from each satellite, in consideration of the additional factors and error sources previously noted. With the distance and location information of the satellites 130, the positioning engine can then determine a position fix for its location. The positioning engine that determines this position fix may comprise, for example, by a Standalone Positioning Engine (SPE) executed by one or more processors of the GNSS receiver 110 and/or an electronic device into which the GNSS receiver 110 is integrated. However, the resulting accuracy of the position fix for the GNSS receiver 110 is subject to errors caused by satellite orbit and clock, ionosphere and troposphere delays, and other phenomena. Code-based GNSS positioning in this manner can provide an accuracy on the order of meters, which may be less than desirable for many applications.

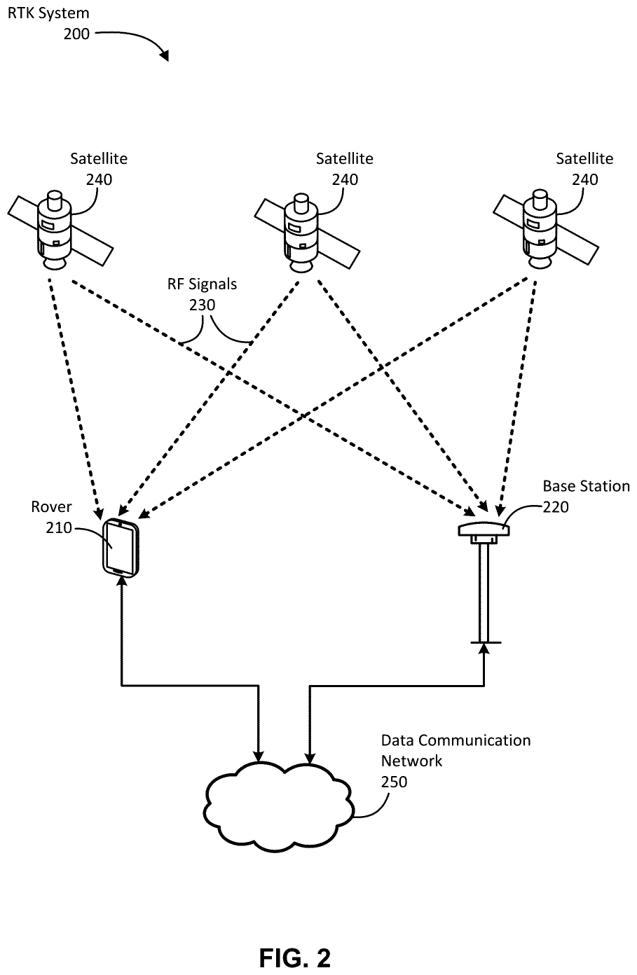

More accurate carrier-based ranging is based on phase of a carrier wave of the RF signals from satellites and may use measurements at a base or reference station. An example of this is illustrated in FIG. 2.

FIG. 2 is a simplified diagram of an embodiment of a Real-Time Kinematic (RTK) system 200. The RTK system 200 enables a highly accurate GNSS position fix of a mobile device, called a rover 210 (or “rover station”), by using GNSS receivers at both the rover 210 and base station 220 that receive RF signals 230 from satellites 240.

Various components of the RTK system 200 of FIG. 2 may correspond with the GNSS system 100 of FIG. 1, including the rover 210, which corresponds to a device comprising the GNSS receiver 110 of FIG. 1 (e.g., mobile phone, tablet, laptop, wearable device, vehicle, or the like); and satellites 240, which correspond to satellites 130. Thus, similar to satellites 130 of FIG. 1, satellites 240 of FIG. 2 may also correspond one or more GNSS constellations, such as GPS, Galileo, GLONASS, Beidou, etc.

RTK positioning can provide a high-accuracy solution by using carrier-based ranging based on the carrier wave of the RF signals 230 and using the base station 220 to make similar observations from a reference location that can be used to make differential corrections of errors from various error sources. The base station 220 comprises a fixed GNSS receiver that, using carrier-based ranging and known position, may provide RTK measurement information (also known as “RTK service data” or “correction information”) that is communicated to the rover 210 via, for example, a data communication network 250 and used by the rover 210 as corrective information to reduce the errors as described above (e.g., orbit and clock errors, ionosphere and troposphere delays, etc.) by comparing the RTK measurement information with measurements of the satellites 240 made by the rover 210 to determine an accurate position fix for the rover 210. This position fix may be determined, for example, by a Precise Positioning Engine (PPE) executed by one or more processors of the rover 210. More specifically, in addition to the information provided to an SPE, the PPE may use RTK measurement information, and additional correction information, such as troposphere and ionosphere, to provide a high accuracy, carrier-based position fix.

Some embodiments of a PPE may perform some error correction at the mobile device (e.g., rover 210). For example, according to some embodiments, mobile device may use a GNSS receiver to make multi-band pseudo-range (PR) and carrier phase (CP) measurement of signals from each of the plurality of satellites 240. PR and CP measurements may correspond with code-based and carrier-based measurements, respectively, as previously described. To make a multi-band measurement (a measurement of signals using two or more frequencies transmitted by a satellite), embodiments may use a multi-band GNSS receiver (e.g., a dual-band receiver, tri-band receiver, etc.) capable of receiving a plurality of frequency bands. Some embodiments may use multi-constellation multi-frequency (MCMF) receivers capable of receiving multiple frequency bands on multiple constellations. Examples of different bands like me used for the multi-band PR/CP measurement at block 210 include, L1/L5 for GPS, E1/E5A for GAL, and B1C/B2A for BDS. Other embodiments may use additional or alternative bands and/or GPS constellations. Using multi-band measurements, and ionosphere-free (IF) combination may be formed. An ionosphere-free combination comprises a linear combination of code and/or carrier measurements that can eliminate first order ionospheric effects from ionospheric refraction, which can increase the accuracy of the positioning solution. Additional errors a be reduced using correction information received from the base station 220.

RTK service data, or correction information, may be relayed from the base station 220 to the rover 210 in different ways, depending on desired functionality. As illustrated, the data may be communicated via a data communication network 250 (e.g., the Internet, public and/or private networks, mobile communications/cellular networks, etc.). Additionally or alternatively base station information may be communicated to the rover 210 via broadcast, unicast, and/or groupcast. This may be done via a wireless network (4G Long-Term Evolution (LTE), 5G New Radio (NR), etc.) via wireless network nodes, such as cellular base stations (Evolved Node B (eNB), gNodeB (gNB), etc.), by broadcast stations at or near base stations 220, and/or other means.

A base station 220 may, in different forms. A physical base station 220 may be located within a geographical area served by the base station 220. However, “virtual” base stations may be created by, for example, a computer server that interpolates information from multiple base stations. By doing so, the server may determine, based on RTK service data received from nearby physical base stations, what RTK service data from a virtual base station would be if located at a given physical location. Additionally, other types of virtual base stations may be created by converting correction information from a Precise Point Positioning (PPP) source to an RTK format and providing the converted information to a rover 210 for positioning. (In such embodiments, the rover 210 may implement specialized software to process the PPP-based information such that it may be used by the PPP executed at the rover 210.) Because base stations may be virtual or physical, base stations also may be referred to herein simply as “correction information sources.”

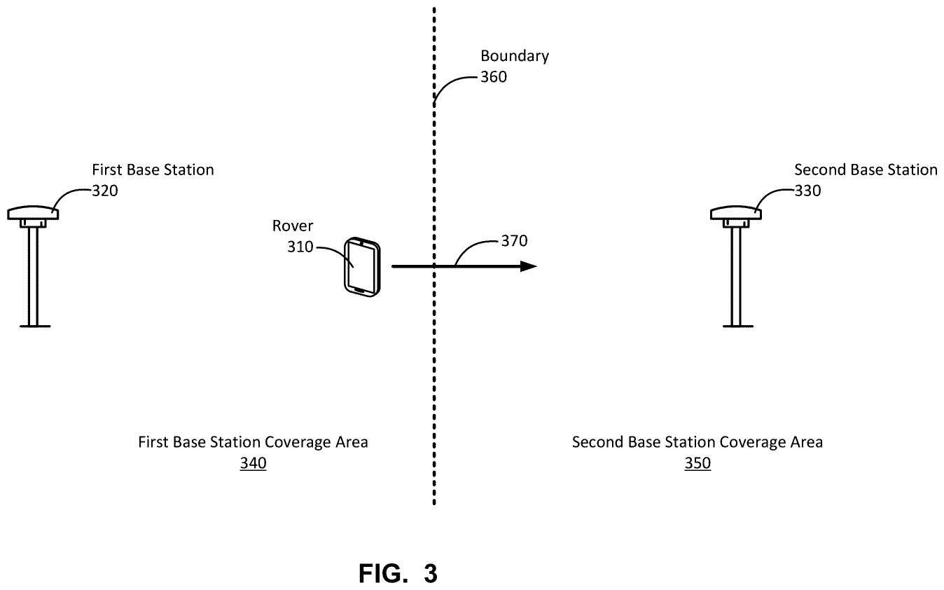

Although a single base station 220 is illustrated in FIG. 2, and RTK system 200 may comprise a network of base stations 220, as previously noted. Because the differential information provided in the RTK service data to the rover 210 by the base station 220 applies to a limited coverage area surrounding the base station 220 (e.g., a few kilometers or tens of kilometers), multiple base stations—physical and/or virtual—may be networked to service a larger geographical region. Thus, when moving through the larger geographical region, a rover 210 may move between coverage areas of different base stations 220. As previously noted, this may trigger the rover 210 to swap base stations when moving from one coverage area to another. An example of this is illustrated in more detail in FIG. 3.

FIG. 3 is a diagram illustrating a scenario in which a rover 310 (e.g., corresponding to rover 210 of FIG. 2) may swap from a first base station 320 to a second base station 330. More specifically, because the rover 310 moves from the first base station coverage area 340 to the second base station coverage area 350 (e.g., by crossing a boundary 360 between the two coverage areas in the direction of the arrow 370), correction information (RTK service data) from the second base station 330 provides a more accurate position fix then correction information from the first base station 320. The boundary 360 between first base station coverage area 340 and a second base station coverage area 350, as well as boundaries between coverage areas of all other base stations in an RTK base station network generally may be determined based on which base station is the closest. That said, a boundary may be determined (e.g., by an RTK service provider and/or by a rover) based on additional or alternative criteria, such as which base station provides correction information resulting in a more accurate position fix.

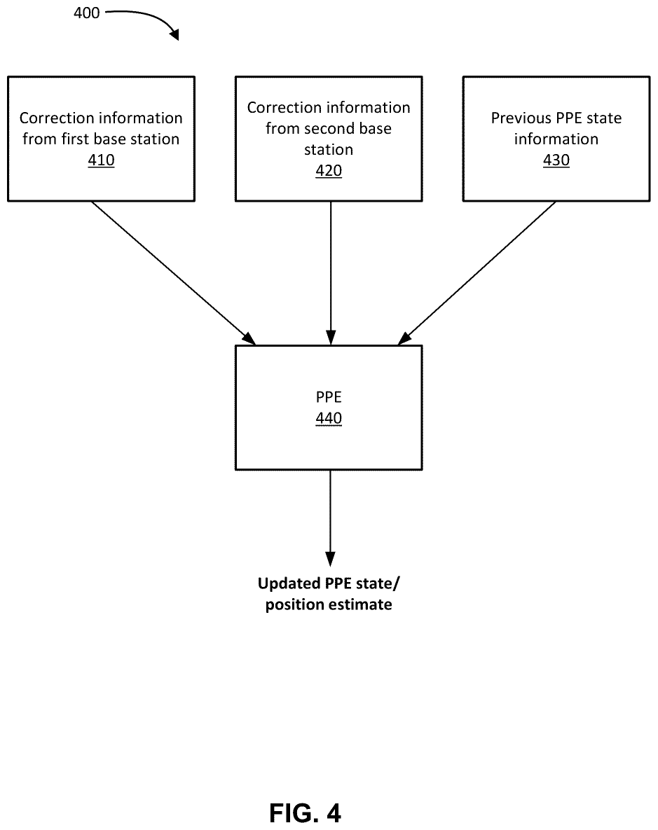

Although the diagram of FIG. 3 illustrates base station swapping between first and second physical base stations, techniques for handling base station swapping provided herein may be utilized by a rover 310 for transitioning between receiving correction information from any two types of correction base stations or information sources. That is, the rover 310 may switch between physical RTK base stations (physical and/or virtual), between an RTK correction information source and a PPP correction information source (e.g., a virtual base station), or switching between two different PPP correction information sources. To do so, embodiments may utilize various data as described in more detail in FIG. 4.

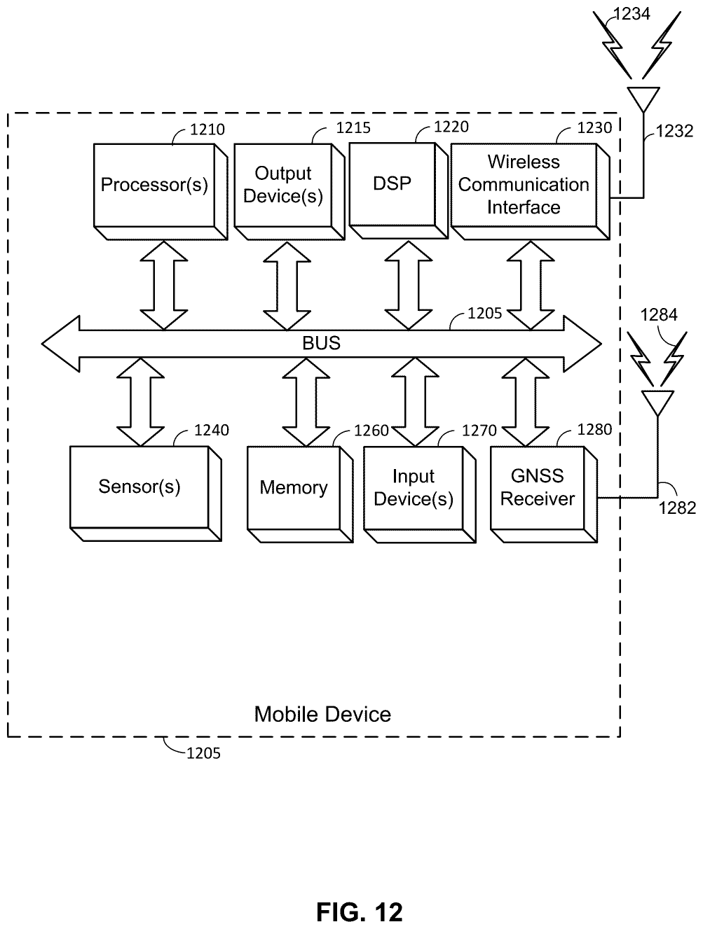

FIG. 4 is a block diagram 400 illustrating how a PPE may utilize various data to generate an updated PPE state (including a position estimate) when switching between a first base station (e.g., first base station 320 of FIG. 3) and a second base station (e.g., second base station 330), according to an embodiment. Here, the PPE engine can be implemented at a mobile device (e.g., a rover) using a position estimator, such as a Kalman Filter (KF) (e.g., an Extended KF (EKF), recursive least square estimator, or another such position estimator used compute device position, executed by hardware and/or software components of the mobile device. Example components are illustrated in FIG. 12 and described in more detail hereafter.

GNSS-based positioning engines such as a PPE may make position estimations and measurements within time periods known as epochs. For real-time applications, the length of each epoch may equal one second, although other embodiments may have epochs of longer or shorter lengths. Thus, as used herein, a “current” time and a “previous” time may refer to current and previous epochs, respectively. With regard to the blocks in FIG. 4, for a current time “TR,” correction information from the first base station 410 and correction information from the second base station 420, as well as previous PPE state information 430 derived from the previous epoch (e.g., time “TR−1”), may be buffered by a mobile device and used to update a PPE 440 to generate an updated PPE state/position estimate for current time “TR.” In this case, previous correction information from the first base station may be used to determine the previous PPE state information 430. As explained in more detail below, the correction information from the first base station 410 and the correction information from the second base station 420 may correlate with the same GNSS time (e.g., the same second of week (SOW)), or may be within a time window (e.g., one second, three seconds, five seconds, 10 seconds, etc.) to help ensure smooth base station swapping by the PPE.

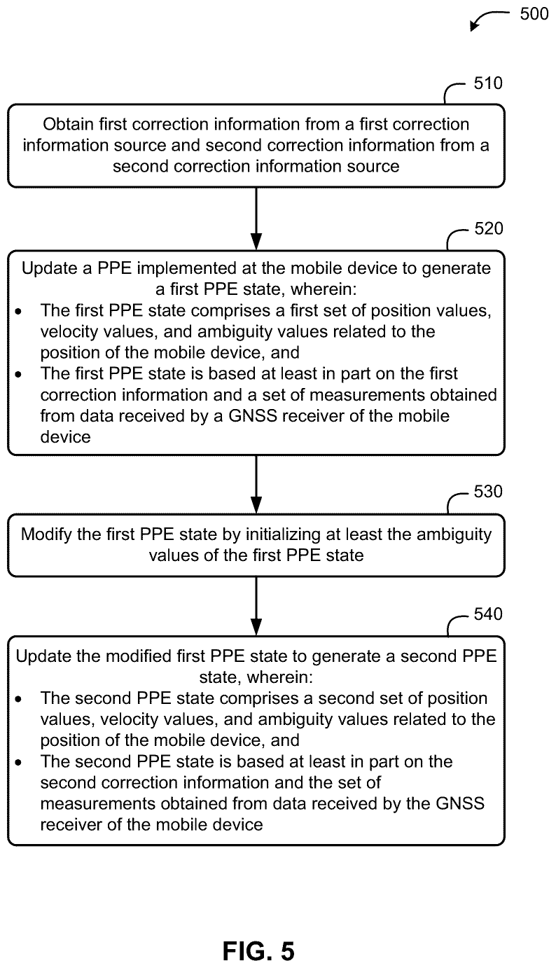

FIG. 5 is a flow diagram illustrating an embodiment of a method 500 of handling a correction information source change for GNSS positioning of a mobile device. In some aspects, the method 500 is a way in which the components of FIG. 4 may be used to provide the updated PPE state. Means by which the operations in the blocks of FIG. 5 may be performed include hardware and/or software components of a mobile device, such as the mobile device 1205 illustrated in FIG. 12, described in more detail hereafter.

At block 510, the functionality comprises obtaining first correction information from a first correction information source and second correction information from a second correction information source. Here, the first correction information source may comprise a first base station from which a mobile device is transitioning, and the second correction information source may comprise a second base station to which the mobile device is transitioning. The correction information may comprise RTK service data and/or similar data, which may be provided in accordance with any applicable standards (e.g., via a Radio Technical Commission for Maritime Services (RTCM) message). Thus, as illustrated in the example that follows, correction information may comprise carrier phase correction. Further, according to some embodiments, a time to which first correction information corresponds may be within 10 seconds of a time to which the second correction information corresponds. Moreover, according to some embodiments, the time to which first correction information corresponds is the same SOW as the time to which the second correction information corresponds

As noted, the correction information sources may comprise sources of the same or different types. In some instances, for example, the first correction information source may comprise a physical RTK base station, a virtual RTK base station, or a PPP source. Moreover, the second correction information source may comprise a different type of correction information source than the first correction information source or the same type of correction information source as the first correction information source.

Means for performing the functionality at block 510 may comprise a wireless communication interface 1230, Digital Signal Processor (DSP) 1220, processor(s) 1210, memory 1260, GNSS receiver 1280, and/or other components of a mobile device, as illustrated in FIG. 12 and described hereafter.

At block 520, the functionality of method 500 comprises updating a PPE implemented at the mobile device to generate a first PPE state, wherein the first PPE state comprises a first set of position values, velocity values, and ambiguity values related to the position of the mobile device, and the first PPE state is based at least in part on the first correction information and a set of measurements obtained from data received by a GNSS receiver of the mobile device. According to some embodiments, position values may comprise an estimated position (e.g., in X, Y, and Z coordinates, as illustrated in FIG. 1) of the mobile device, velocity values may comprise velocity information in each of three dimensions (e.g., X, Y, and Z), and ambiguity values may comprise an ambiguity term (in cycles) of carrier phase position estimation.

Means for performing the functionality at block 520 may comprise a wireless communication interface 1230, DSP 1220, processor(s) 1210, memory 1260, GNSS receiver 1280, and/or other components of a mobile device, as illustrated in FIG. 12 and described hereafter.

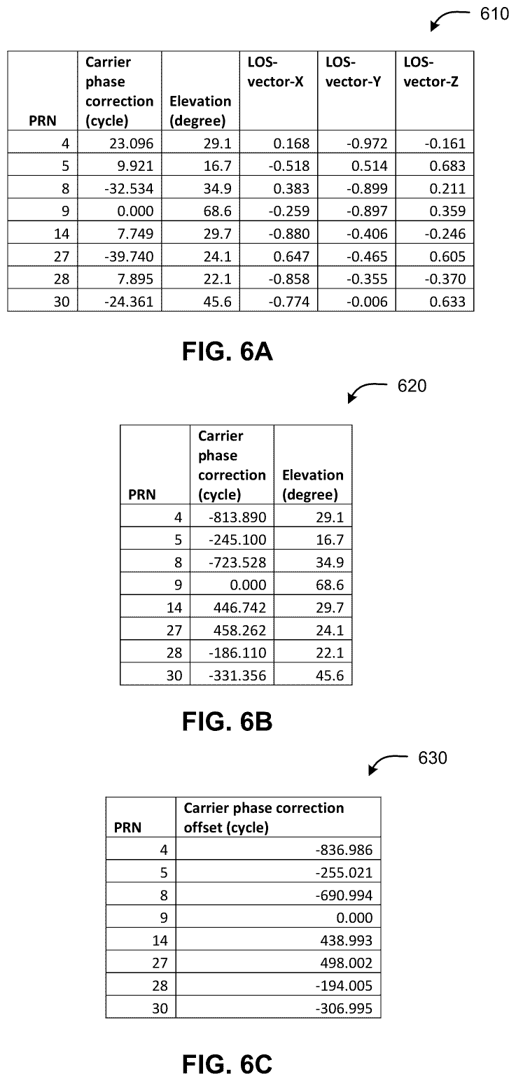

The functionality at block 530 comprises modifying the first PPE state by initializing at least the ambiguity values of the first PPE state. As illustrated in the example of FIGS. 6A-10, discussed hereafter, the initialization of at least the ambiguity values may comprise setting the ambiguity values of the first PPE state with values calculated by using any of a variety of techniques for determining ambiguity state initialization values. For example, according to some embodiments, the ambiguity state values may be set based on the difference between pseudo-range geometric range and carrier phase geometric range. Additionally or alternatively, position values of the first PPE state and the carrier-phase measurements from the correction information of the second correction information source may be used to calculate the satellite position for each satellite. Geometry range can then be extracted from position values and satellite position and subtracted from range determined using pseudo-range positioning to determine the initialized ambiguity state values. Additional and/or alternative techniques for setting ambiguity state values may be performed in other embodiments.

Means for performing the functionality at block 530 may comprise a wireless communication interface 1230, DSP 1220, processor(s) 1210, memory 1260, GNSS receiver 1280, and/or other components of a mobile device, as illustrated in FIG. 12 and described hereafter.

The functionality at block 540 comprises updating the modified first PPE state to generate a second PPE state, wherein (i) the second PPE state comprises a second set of position values, velocity values, and ambiguity values related to the position of the mobile device, and (ii) the second PPE state is based at least in part on the second correction information and the set of measurements obtained from data received by the GNSS receiver of the mobile device. Again, according to some embodiments, updating the modified first PPE state to generate the second PPE state may comprise updating the modified first PPE state without a time update of the PPE

Means for performing the functionality at block 540 may comprise a wireless communication interface 1230, DSP 1220, processor(s) 1210, memory 1260, GNSS receiver 1280, and/or other components of a mobile device, as illustrated in FIG. 12 and described hereafter.

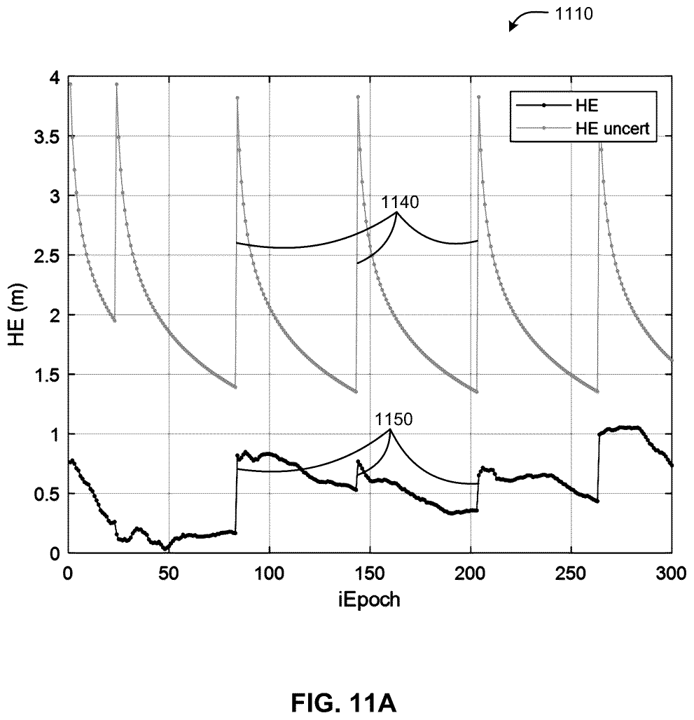

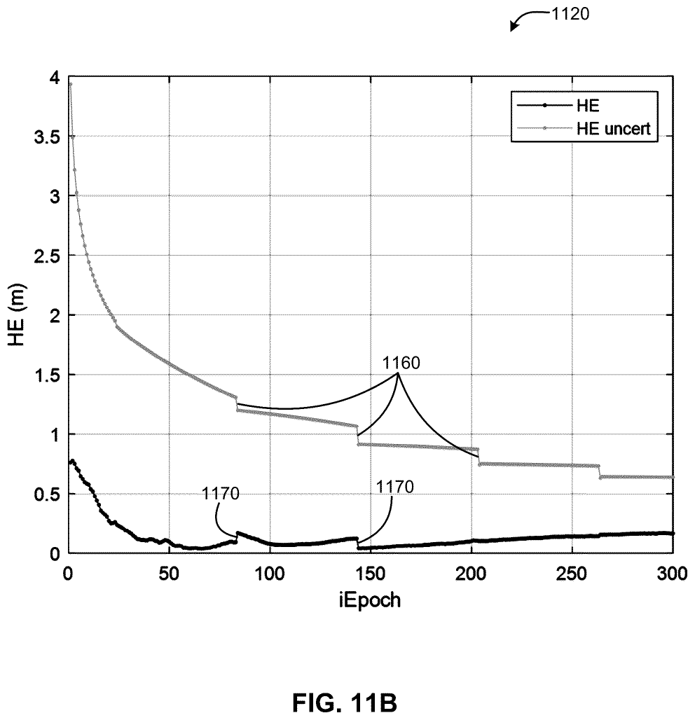

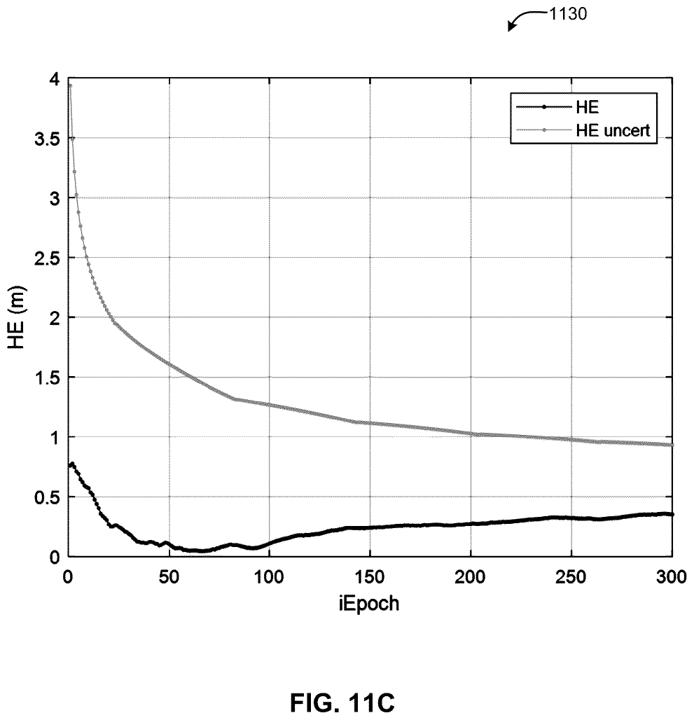

Some embodiments of the method 500 may include additional features, depending on desired functionality. For example, according to some embodiments (e.g., embodiments used to provide the simulation results illustrated in FIG. 11B and described in more detail below), modifying the first PPE state further comprises initializing the position values and the velocity values of the first PPE state. That is, in such embodiments, the first PPE state may be modified by initializing all the position estimator state values (including position, velocity, and ambiguity) by using the second correction information to receive the second PPE state.

Further, in such embodiments, once the second PPE state is determined, the second PPE state may be updated with a “pseudo-measurement” using position (X,Y,Z) values (vector size 3 by 1) from the first PPE state as a position constraint. Thus, some embodiments of the method 500 may further comprise updating the second PPE state using position values from the first PPE state.

Uncertainty for the values, known as the R matrix, may be configured in accordance with different methods, depending on desired functionality. In a first method, the R matrix (a 3×3 matrix) may be configured directly using the position covariance extracted from the first PPE state covariance matrix. Thus, some embodiments of the method 500 in which the second PPE state is updated using the position values from the first PPE state, embodiments may further comprise setting an uncertainty of the position values based on position variance values of the first PPE state. In a second method, the R matrix may be configured with very small values (e.g., 10 cm, 5 cm, 1 cm, or less). After the pseudo-measurement update to the second PPE state, further changes to the second PPE state covariance matrix may be performed. The position variance and ambiguity variance components in the second PPE state covariance (matrix diagonal part) may be replaced by the corresponding values in the first PPE state covariance. Thus, some embodiments of the method 500 in which the second PPE state is updated using the position values from the first PPE state, embodiments may further comprise setting an uncertainty of the position values using one or more predetermined values. This may be done, for example, based, at least in part, on a determination that position variance values of the first PPE state exceed a threshold value.

FIGS. 6A-10 are a series of tables illustrating values for correction data and PPE states used in an example transition of a mobile device from a first correction information source to a second correction information source, according to an embodiment.

FIG. 6A illustrates a table 610 illustrating correction information from the first correction information source. In this table 610, the first column represents Pseudo-Random Noise (PRN) sequences from different satellites, effectively identifying the satellite corresponding to each row in the table. As further indicated, carrier phase correction and elevation information are provided for each satellite, along with LOS vector information for X, Y, and Z dimensions. It can be noted that, while correction information typically includes carrier phase correction, it may not contain the elevation and LOS vector information, which can be computed at the device. This information is included in table 610 for illustrative purposes. For example, elevation is shown to indicate why satellite PRN 9 is selected as a reference satellite, and LOS is shown to verify how the effective ambiguity offset equals to the correction offset. FIG. 6B illustrates a table 620 illustrating similar correction information (minus the LOS vector information) for the same satellites from a second correction information source. The correction information of the tables 610 and 620 may be considered correction information for a current time (e.g., time “TR”). That said, as previously indicated, the observations made by the base stations may take place at different GNSS times (e.g., different SOW), which may differ according to some embodiments, by up to 10 seconds. Other embodiments may allow for larger or smaller time differences. FIG. 6C illustrates a table 630 indicating the carrier phase correction offset (or carrier phase correction difference) between tables 610 and 620.

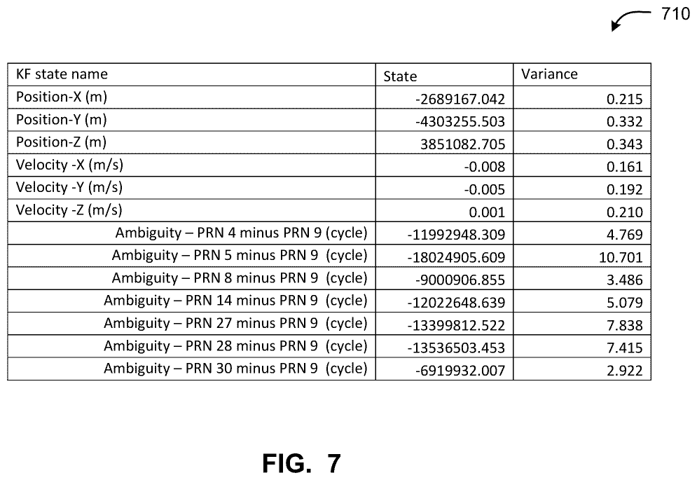

FIG. 7 illustrates a table 710 illustrating values of a first PPE state after the PPE engine applies the correction information of table 610 to a previous PPE state (e.g., in a position estimator measurement update). In other words, table 710 shows PPE state values for a current time, TR, after the correction information from the first correction information source is applied to the PPE state of the previous time, TR−1. As shown, the first PPE state includes state and variance values for estimated position, velocity, and ambiguity. The position and velocity values are provided in X, Y, and Z coordinates and represent estimated position and velocity of the mobile device. Ambiguity state values are provided in relation to a reference satellite (PRN 9 in table 710), which is typically selected as the satellite having the highest elevation (e.g., closest to overhead).

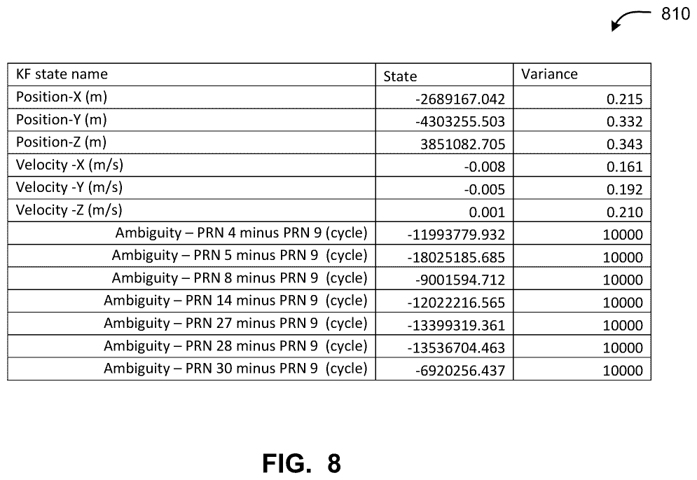

FIG. 8 illustrates a table 810 illustrating modified values of the first PPE state (of table 710) after initializing the ambiguity values. As can be seen, ambiguity variance values are set at 10,000, although alternative embodiments may set variance values at a higher or lower number. Generally put, ambiguity variance values can be based on the accuracy of the initialized ambiguity state values.

As previously noted, with regard to the ambiguity state values, they may be calculated by using any of a variety of techniques for setting ambiguity state values. This may be done, for example, by setting ambiguity state values based on the difference between pseudo-range geometric range and carrier phase geometric range. Additionally or alternatively, the satellite position for each satellite may be calculated based on position values of the first PPE state (table 710) and the carrier-phase measurements from the correction information of the second correction information source (table 620). Geometry range can then be extracted from position values and satellite position and subtracted from range determined using pseudo-range positioning to determine the initialized ambiguity state values of table 810. Additional and/or alternative techniques for setting ambiguity state values may be performed in other embodiments.

As previously noted, according to some embodiments, position and velocity values may be initialized in a similar manner. However, initializing only the variance values may result in less change in horizontal error (HE) during the transition from the first correction information source to the second correction information source, as illustrated in FIGS. 11A-11C, which is described in more detail hereafter.

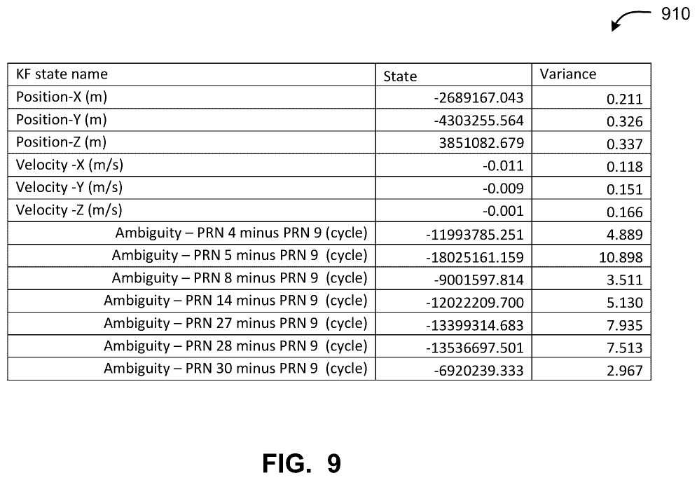

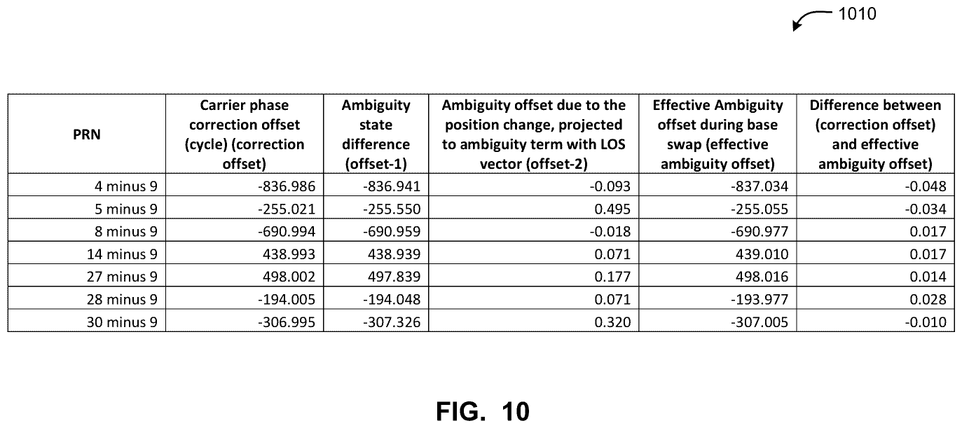

FIG. 9 illustrates a table 910 illustrating a second PPE state. The values of table 910 represent an update to the modified first PPE state of table 810 based on the correction information from the second correction information source (table 620). This update may represent a position estimator measurement update of the PPE, without a time update. That is, the current time of the second PPE state (table 910) may correspond with the same time (e.g., time TR) as the time of the first PPE state (table 710). The second PPE state results in ambiguity state values that automatically handle the correction offset, aligning (e.g., minimizing the difference between) the correction offset and the effective ambiguity offset. This is explained in more detail in FIG. 10.

FIG. 10 illustrates a table 1010 that summarizes key values from the base station swap handling example illustrated in FIGS. 6A-9, showing differential values between the various satellites in the reference satellite (PRN 9). Carrier phase correction offset values show the values of table 630, which is the difference between carrier phase correction in tables 610 and 620 from first and the second correction information sources. Ambiguity state difference values show the difference between ambiguity state values in the first PPE state at table 710 and the second PPE state at table 910. Further, the values in table 1010 for the ambiguity offset due to the position change projected to the ambiguity term with LOS vector comprise the difference between position values of in the first PPE state at table 710 and the second PPE state at table 910, projected onto the LOS vector of each satellite at table 610. Values for the effective ambiguity offset during base swap are derived from the summation of the previous two columns ((i) ambiguity state difference, and (ii) ambiguity offset due to the position change projected to ambiguity term with LOS vector) and reflect the true ambiguity offset of the transition from first correction information source to the second correction information source. And finally, the difference between correction offset and effective ambiguity offset provides a metric of how the ambiguity in the PPE aligns with the correction offset during the transition. As can be seen, these difference values are relatively small (all less than 0.05 cycle, amounting to less than 1 cm), indicating the effectiveness of utilizing the techniques described herein for handling correction information source (base station) swapping in enabling this alignment. This results in smooth transitions from the standpoint of the mobile device, as illustrated in more detail in FIGS. 11A-11C.

FIGS. 11A-11C illustrate graphs 1110, 1120, and 1130 that plot simulated values for HE and HE uncertainty over time using different techniques for handling correction information source (base station) swapping. Here, each iEpoch may represent one second. Further, in the simulations used to create these graphs 1110, 1120, and 1130, transitions were simulated every 60 iEpochs (e.g., every 60 seconds), starting after approximately 20 iEpochs into the simulation.

Graph 1110 of FIG. 11A represents a scenario in which transitions between correction information sources result in a resetting of the PPE. As can be seen in graph 1110, this results in large, abrupt transitions 1140 in the HE uncertainty (only a few of which are labeled in FIG. 11A, to avoid clutter), and corresponding transitions 1150 in the HE itself. For navigation and similar applications, this can result in an undesirable user experience in which corresponding abrupt changes occur in the estimated location of the user at each transition.

Graph 1120 of FIG. 11B represents a scenario in which transitions between correction information sources are handled in accordance with a first embodiment. This embodiment reflects a variation of the method described in FIG. 5, where the values of the first PPE state are modified by initializing ambiguity, position, and velocity values. As previously noted, once the second state is determined (upon updating the modified first PPE state using the correction information from the second correction information source) a pseudo-measurement update can be performed on the second state using the position values of the first PPE state. As further noted, the uncertainty of this pseudo-measurement, known as the R matrix, may be selected using different methods.

As can be seen in graph 1120, this results in abrupt transitions 1160 in the HE uncertainty that are far smaller than corresponding transitions 1140 in FIG. 11A. The amplitude of the transitions 1170 in the HE is also reduced when compared with corresponding transitions 1150 of 11A. Such transitions are far less noticeable from the perspective of the mobile device (e.g., a software application executed by the mobile device) and/or user of the mobile device.

Graph 1130 of FIG. 11C represents a scenario in which transitions between correction information sources are handled in accordance with a second embodiment. This embodiment reflects another variation of the method described in FIG. 5, where the values of the first PPE state are modified by initializing only the ambiguity values (e.g., in the manner illustrated in FIG. 8). As can be seen in graph 1130, this results in even smoother transitions between correction information sources than graph 1120, with no abrupt changes in HE uncertainty or HE. Again, this can result in a better user experience.

FIG. 12 is a block diagram of various hardware and software components of a mobile device 1200, according to an embodiment. These components can be utilized as described herein above (e.g. in association with FIGS. 1-11). For example, the mobile device 1200 can perform the operations of the method illustrated in FIG. 5, and/or one or more of the functions of a GNSS receiver as described in the embodiments herein. It should be noted that FIG. 12 is meant only to provide a generalized illustration of various components, any or all of which may be utilized as appropriate. As previously noted, mobile device 1200 may vary in form and function, and may ultimately comprise any GNSS-enabled device, or rover, as described herein. This may include vehicles, commercial and consumer electronic devices, survey equipment, and more. Thus, in some instances, components illustrated by FIG. 12 can be localized to a single physical device and/or distributed among various networked devices, which may be disposed at different physical locations (e.g., different locations of a vehicle). It can be further noted that reference stations may utilize hardware and/or software components similar to the mobile device 1200.

The mobile device 1200 is shown comprising hardware elements that can be electrically coupled via a bus 1205 (or may otherwise be in communication, as appropriate). The hardware elements may include a processor(s) 1210 which can include without limitation one or more general-purpose processors, one or more special-purpose processors (such as DSP chips, graphics processors (GPUs), application specific integrated circuits (ASICs), and/or the like), and/or other processor, processing structure, processing unit, or processing means. As shown in FIG. 12, some embodiments may have a separate DSP 1220, depending on desired functionality. Location determination and/or other determinations based on wireless communication may be provided in the processor(s) 1210 and/or wireless communication interface 1230 (discussed below). The mobile device 1200 also can include one or more input devices 1270, which can include without limitation a keyboard, touch screen, a touch pad, microphone, button(s), dial(s), switch(es), and/or the like; and one or more output devices 1215, which can include without limitation a display, light emitting diode (LED), speakers, and/or the like. As will be appreciated, the type of input devices 1270 and output devices 1215 may depend on the type of mobile device 1200 with which the input devices 1270 and output devices 1215 are integrated.

The mobile device 1200 may also include a wireless communication interface 1230, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX™ device, a Wide Area Network (WAN) device and/or various cellular devices, etc.), and/or the like, which may enable the mobile device 1200 to communicate via networks and/or directly with other devices as described herein. The wireless communication interface 1230 may permit data and signaling to be communicated (e.g. transmitted and received) with a network, for example, via WAN access points, cellular base stations and/or other access node types, and/or other network components, computer systems, and/or any other electronic devices described herein. The communication can be carried out via one or more wireless communication antenna(s) 1232 that send and/or receive wireless signals 1234. The antenna(s) 1232 may comprise one or more discrete antennas, one or more antenna arrays, or any combination.

Depending on desired functionality, the wireless communication interface 1230 may comprise separate transceivers, a separate receiver and transmitter, or any combination of transceivers, transmitters, and/or receivers to communicate with base stations and other terrestrial transceivers, such as wireless devices and access points. The mobile device 1200 may communicate with different data networks that may comprise various network types. For example, a Wireless Wide Area Network (WWAN) may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX™ (IEEE 802.16) network, and so on. A CDMA network may implement one or more radio access technologies (RATs) such as CDMA2000®, Wideband CDMA (WCDMA), and so on. CDMA2000® includes IS-95, IS-2000, and/or IS-856 standards. A TDMA network may implement Global System for Mobile Communications (GSM), Digital Advanced Mobile Phone System (D-AMPS), or some other RAT. An OFDMA network may employ LTE, LTE Advanced, 5G NR, 6G, and so on. 5G NR, LTE, LTE Advanced, GSM, and WCDMA are described in documents from the Third Generation Partnership Project (3GPP™). CDMA2000® is described in documents from a consortium named “3rd Generation Partnership Project 2” (3GPP2). 3GPP™ and 3GPP2 documents are publicly available. A wireless local area network (WLAN) may also be an IEEE 802.11x network, and a wireless personal area network (WPAN) may be a Bluetooth® network, an IEEE 802.15x, or some other type of network. The techniques described herein may also be used for any combination of WWAN, WLAN and/or WPAN.

The mobile device 1200 can further include sensor(s) 1240. Sensors 1240 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to complement and/or facilitate the location determination described herein, in some instances.

Embodiments of the mobile device 1200 may also include a GNSS receiver 1280 capable of receiving signals 1284 from one or more GNSS satellites (e.g., satellites 130) as described herein using an antenna 1282 (which could be the same as antenna 1232). As previously described, GNSS receiver 1280 can extract a position of the mobile device 1200, using conventional techniques, from GNSS SVs of a GNSS system (e.g., SVs 140 of FIG. 3), such as GPS, GAL, GLONASS, Quasi-Zenith Satellite System (QZSS) over Japan, IRNSS over India, BDS over China, and/or the like. Moreover, the GNSS receiver 1280 can be used with various augmentation systems (e.g., SBAS) that may be associated with or otherwise enabled for use with one or more global and/or regional navigation satellite systems, such as, e.g., WAAS, EGNOS, Multi-functional Satellite Augmentation System (MSAS), and GAGAN, and/or the like.

It can be noted that, although GNSS receiver 1280 illustrated in FIG. 12 is illustrated as a component distinct from other components within a mobile device 1200, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1210, DSP 1220, and/or a processor within the wireless communication interface 1230 (e.g., in a modem). A GNSS receiver may optionally also include a positioning engine, such as those described herein (e.g., a PPE, which may be based on a position estimator, such as a KF, Weighted Least Squares (WLS), particle filter, etc.), which can use GNSS measurements from the measurement engine, and correction information as described herein, to determine a position of the GNSS receiver. The positioning engine may also be executed by one or more processors, such as processor(s) 1210 and/or DSP 1220.

The mobile device 1200 may further include and/or be in communication with a memory 1260. The memory 1260 may comprise a machine- or computer-readable medium, which can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1260 of the mobile device 1200 also can comprise software elements (not shown in FIG. 12), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1260 that are executable by the mobile device 1200 (and/or processor(s) 1210 or DSP 1220 within mobile device 1200). In an aspect, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device or system is capable of manipulating or transforming signals, typically represented as physical electronic, electrical, or magnetic quantities within memories, registers, or other information storage devices, transmission devices, or display devices of the special purpose computer or similar special purpose electronic computing device or system.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure as defined by the appended claims. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of handling a correction information source change for Global Navigation Satellite System (GNSS) positioning of a mobile device, the method comprising: obtaining first correction information from a first correction information source and second correction information from a second correction information source; updating a Precise Positioning Engine (PPE) implemented at the mobile device to generate a first PPE state, wherein: the first PPE state comprises a first set of position values, velocity values, and ambiguity values related to the position of the mobile device, and the first PPE state is based at least in part on the first correction information and a set of measurements obtained from data received by a GNSS receiver of the mobile device; modifying the first PPE state by initializing at least the ambiguity values of the first PPE state; and updating the modified first PPE state to generate a second PPE state, wherein: the second PPE state comprises a second set of position values, velocity values, and ambiguity values related to the position of the mobile device, and the second PPE state is based at least in part on the second correction information and the set of measurements obtained from data received by the GNSS receiver of the mobile device.
Clause 2. The method of clause 1, wherein updating the modified first PPE state to generate the second PPE state comprises updating the modified first PPE state without a time update of the PPE.
Clause 3. The method of any of clauses 1-2 wherein a time to which first correction information corresponds is within 10 seconds of a time to which the second correction information corresponds.
Clause 4. The method of any of clauses 1-3 wherein the time to which first correction information corresponds is a same second-of-week (SOW) as the time to which the second correction information corresponds.
Clause 5. The method of any of clauses 1-4 wherein the first correction information source comprises a physical Real-Time Kinematic (RTK) base station, a virtual RTK base station, or a Precise Point Positioning (PPP) source.
Clause 6. The method of any of clauses 1-5 wherein the second correction information source comprises a different type of correction information source than the first correction information source.
Clause 7. The method of any of clauses 1-5 wherein the second correction information source comprises a same type of correction information source as the first correction information source.
Clause 8. The method of any of clauses 1-7 wherein modifying the first PPE state further comprises initializing the position values and the velocity values of the first PPE state.
Clause 9. The method of any of clauses 1-8 further comprising updating the second PPE state using the position values from the first PPE state.
Clause 10. The method of any of clauses 1-9 wherein updating the second PPE state further comprises setting an uncertainty of the position values based on position variance values of the first PPE state.
Clause 11. The method of any of clauses 1-10 wherein updating the second PPE state further comprises setting an uncertainty of the position values of the second PPE state using one or more predetermined values.
Clause 12. The method of clause 11 wherein setting the uncertainty of the position values the second PPE state using the one or more predetermined values is based, at least in part, on a determination that position variance values of the first PPE state exceed a threshold value.
Clause 13. A mobile device for handling a correction information source change for Global Navigation Satellite System (GNSS) positioning of a mobile device, the mobile device comprising: a GNSS receiver; a memory; and one or more processors communicatively coupled with the GNSS receiver and the memory, wherein the one or more processors are configured to: obtain first correction information from a first correction information source and second correction information from a second correction information source; update a Precise Positioning Engine (PPE) implemented at the mobile device to generate a first PPE state, wherein: the first PPE state comprises a first set of position values, velocity values, and ambiguity values related to the position of the mobile device, and the first PPE state is based at least in part on the first correction information and a set of measurements obtained from data received by the GNSS receiver of the mobile device; modify the first PPE state by initializing at least the ambiguity values of the first PPE state; and update the modified first PPE state to generate a second PPE state, wherein: the second PPE state comprises a second set of position values, velocity values, and ambiguity values related to the position of the mobile device, and the second PPE state is based at least in part on the second correction information and the set of measurements obtained from data received by the GNSS receiver of the mobile device.
Clause 14. The mobile device of clause 13, wherein, to update the modified first PPE state to generate the second PPE state, the one or more processors are configured to update the modified first PPE state without a time update of the PPE.
Clause 15. The mobile device of any of clauses 13-14 wherein the one or more processors are configured to obtain the first correction information and the second correction information such that a time to which the first correction information corresponds is within 10 seconds of a time to which the second correction information corresponds.
Clause 16. The mobile device of any of clauses 13-15 wherein the one or more processors are configured to obtain the first correction information and the second correction information such that the time to which the first correction information corresponds is a same second-of-week (SOW) as the time to which the second correction information corresponds.
Clause 17. The mobile device of any of clauses 13-16 wherein the first correction information source comprises a physical Real-Time Kinematic (RTK) base station, a virtual RTK base station, or a Precise Point Positioning (PPP) source.
Clause 18. The mobile device of any of clauses 13-17 wherein the second correction information source comprises a different type of correction information source than the first correction information source.
Clause 19. The mobile device of any of clauses 13-17 wherein the second correction information source comprises a same type of correction information source as the first correction information source.
Clause 20. The mobile device of any of clauses 13-19 wherein, to modify the first PPE state, the one or more processors are configured to initialize the position values and the velocity values of the first PPE state.
Clause 21. The mobile device of any of clauses 13-20 wherein the one or more processors are further configured to update the second PPE state using the position values from the first PPE state.
Clause 22. The mobile device of any of clauses 13-21 wherein, to update the second PPE state, the one or more processors are configured to set an uncertainty of the position values based on position variance values of the first PPE state.
Clause 23. The mobile device of any of clauses 13-22 wherein, to update the second PPE state, the one or more processors are configured to set an uncertainty of the position values of the second PPE state using one or more predetermined values.
Clause 24. The mobile device of clause 23 wherein the one or more processors are configured to set the uncertainty of the position values the second PPE state using the one or more predetermined values based, at least in part, on a determination that position variance values of the first PPE state exceed a threshold value.
Clause 25. An apparatus for handling a correction information source change for Global Navigation Satellite System (GNSS) positioning of a mobile device, the apparatus comprising: means for obtaining first correction information from a first correction information source and second correction information from a second correction information source; means for updating a Precise Positioning Engine (PPE) implemented at the mobile device to generate a first PPE state, wherein: the first PPE state comprises a first set of position values, velocity values, and ambiguity values related to the position of the mobile device, and the first PPE state is based at least in part on the first correction information and a set of measurements obtained from data received by a GNSS receiver of the mobile device; means for modifying the first PPE state by initializing at least the ambiguity values of the first PPE state; and means for updating the modified first PPE state to generate a second PPE state, wherein: the second PPE state comprises a second set of position values, velocity values, and ambiguity values related to the position of the mobile device, and the second PPE state is based at least in part on the second correction information and the set of measurements obtained from data received by the GNSS receiver of the mobile device.
Clause 26. The apparatus of clause 25, wherein the means for updating the modified first PPE state to generate the second PPE state comprises means for updating the modified first PPE state without a time update of the PPE.
Clause 27. The apparatus of any of clauses 25-26 wherein the first correction information source comprises a physical Real-Time Kinematic (RTK) base station, a virtual RTK base station, or a Precise Point Positioning (PPP) source.
Clause 28. The apparatus of any of clauses 25-27 wherein the second correction information source comprises a different type of correction information source than the first correction information source.
Clause 29. The apparatus of any of clauses 25-27 wherein the second correction information source comprises a same type of correction information source as the first correction information source.
Clause 30. The apparatus of any of clauses 25-29 wherein the means for modifying the first PPE state further comprises means for initializing the position values and the velocity values of the first PPE state.
Clause 31. The apparatus of any of clauses 25-30 further comprising means for updating the second PPE state using the position values from the first PPE state.
Clause 32. The apparatus of any of clauses 25-31 wherein the means for updating the second PPE state further comprises means for setting an uncertainty of the position values based on position variance values of the first PPE state.
Clause 33. The apparatus of any of clauses 25-32 wherein the means for updating the second PPE state further comprises means for setting an uncertainty of the position values of the second PPE state using one or more predetermined values.
Clause 34. The apparatus of any of clauses 25-33 wherein setting the uncertainty of the position values the second PPE state using the one or more predetermined values is based, at least in part, on a determination that position variance values of the first PPE state exceed a threshold value.
Clause 35. A non-transitory computer-readable medium storing instructions for handling a correction information source change for Global Navigation Satellite System (GNSS) positioning of a mobile device, the instructions comprising code for: obtaining first correction information from a first correction information source and second correction information from a second correction information source; updating a Precise Positioning Engine (PPE) implemented at the mobile device to generate a first PPE state, wherein: the first PPE state comprises a first set of position values, velocity values, and ambiguity values related to the position of the mobile device, and the first PPE state is based at least in part on the first correction information and a set of measurements obtained from data received by a GNSS receiver of the mobile device; modifying the first PPE state by initializing at least the ambiguity values of the first PPE state; and updating the modified first PPE state to generate a second PPE state, wherein: the second PPE state comprises a second set of position values, velocity values, and ambiguity values related to the position of the mobile device, and the second PPE state is based at least in part on the second correction information and the set of measurements obtained from data received by the GNSS receiver of the mobile device.
Clause 36. The computer-readable medium of clause 35, wherein the code for updating the modified first PPE state to generate the second PPE state comprises code for updating the modified first PPE state without a time update of the PPE.
Clause 37. The computer-readable medium of any of clauses 35-36 wherein the code for modifying the first PPE state comprises code for initializing the position values and the velocity values of the first PPE state.
Clause 38. The computer-readable medium of any of clauses 35-37 wherein the instructions further comprise code for updating the second PPE state using the position values from the first PPE state.
Clause 39. The computer-readable medium of any of clauses 35-38 wherein the code for updating the second PPE state comprises code for setting an uncertainty of the position values based on position variance values of the first PPE state.
Clause 40. The computer-readable medium of any of clauses 35-39 wherein the code for updating the second PPE state comprises code for setting an uncertainty of the position values of the second PPE state using one or more predetermined values.

What is claimed is:

1. A method of handling a correction information source change for Global Navigation Satellite System (GNSS) positioning of a mobile device, the method comprising:
obtaining first correction information from a first correction information source and second correction information from a second correction information source;
updating a Precise Positioning Engine (PPE) implemented at the mobile device to generate a first PPE state, wherein:
the first PPE state comprises a first set of position values, velocity values, and ambiguity values related to the position of the mobile device, and
the first PPE state is based at least in part on the first correction information and a set of measurements obtained from data received by a GNSS receiver of the mobile device;
modifying the first PPE state by initializing at least the ambiguity values of the first PPE state; and
updating the modified first PPE state to generate a second PPE state, wherein:
the second PPE state comprises a second set of position values, velocity values, and ambiguity values related to the position of the mobile device, and
the second PPE state is based at least in part on the second correction information and the set of measurements obtained from data received by the GNSS receiver of the mobile device.

2. The method of claim 1, wherein updating the modified first PPE state to generate the second PPE state comprises updating the modified first PPE state without a time update of the PPE.

3. The method of claim 1, wherein a time to which first correction information corresponds is within 10 seconds of a time to which the second correction information corresponds.

4. The method of claim 3, wherein the time to which first correction information corresponds is a same second-of-week (SOW) as the time to which the second correction information corresponds.

5. The method of claim 1, wherein the first correction information source comprises a physical Real-Time Kinematic (RTK) base station, a virtual RTK base station, or a Precise Point Positioning (PPP) source.

6. The method of claim 5, wherein the second correction information source comprises a different type of correction information source than the first correction information source.

7. The method of claim 5, wherein the second correction information source comprises a same type of correction information source as the first correction information source.

8. The method of claim 1, wherein modifying the first PPE state further comprises initializing the position values and the velocity values of the first PPE state.

9. The method of claim 8, further comprising updating the second PPE state using the position values from the first PPE state.

10. The method of claim 9, wherein updating the second PPE state further comprises setting an uncertainty of the position values based on position variance values of the first PPE state.

11. The method of claim 9, wherein updating the second PPE state further comprises setting an uncertainty of the position values of the second PPE state using one or more predetermined values.

12. The method of claim 11, wherein setting the uncertainty of the position values the second PPE state using the one or more predetermined values is based, at least in part, on a determination that position variance values of the first PPE state exceed a threshold value.

13. A mobile device for handling a correction information source change for Global Navigation Satellite System (GNSS) positioning of a mobile device, the mobile device comprising:
a GNSS receiver;
a memory; and
one or more processors communicatively coupled with the GNSS receiver and the memory, wherein the one or more processors are configured to:
obtain first correction information from a first correction information source and second correction information from a second correction information source;
update a Precise Positioning Engine (PPE) implemented at the mobile device to generate a first PPE state, wherein:
the first PPE state comprises a first set of position values, velocity values, and ambiguity values related to the position of the mobile device, and
the first PPE state is based at least in part on the first correction information and a set of measurements obtained from data received by the GNSS receiver of the mobile device;
modify the first PPE state by initializing at least the ambiguity values of the first PPE state; and
update the modified first PPE state to generate a second PPE state, wherein:
the second PPE state comprises a second set of position values, velocity values, and ambiguity values related to the position of the mobile device, and
the second PPE state is based at least in part on the second correction information and the set of measurements obtained from data received by the GNSS receiver of the mobile device.

14. The mobile device of claim 13, wherein, to update the modified first PPE state to generate the second PPE state, the one or more processors are configured to update the modified first PPE state without a time update of the PPE.

15. The mobile device of claim 13, wherein the one or more processors are configured to obtain the first correction information and the second correction information such that a time to which the first correction information corresponds is within 10 seconds of a time to which the second correction information corresponds.

16. The mobile device of claim 15, wherein the one or more processors are configured to obtain the first correction information and the second correction information such that the time to which the first correction information corresponds is a same second-of-week (SOW) as the time to which the second correction information corresponds.

17. The mobile device of claim 13, wherein the first correction information source comprises a physical Real-Time Kinematic (RTK) base station, a virtual RTK base station, or a Precise Point Positioning (PPP) source.

18. The mobile device of claim 17, wherein the second correction information source comprises a different type of correction information source than the first correction information source.

19. The mobile device of claim 17, wherein the second correction information source comprises a same type of correction information source as the first correction information source.

20. The mobile device of claim 13, wherein, to modify the first PPE state, the one or more processors are configured to initialize the position values and the velocity values of the first PPE state.

21. The mobile device of claim 20, wherein the one or more processors are further configured to update the second PPE state using the position values from the first PPE state.

22. The mobile device of claim 21, wherein, to update the second PPE state, the one or more processors are configured to set an uncertainty of the position values based on position variance values of the first PPE state.

23. The mobile device of claim 21, wherein, to update the second PPE state, the one or more processors are configured to set an uncertainty of the position values of the second PPE state using one or more predetermined values.

24. The mobile device of claim 23, wherein the one or more processors are configured to set the uncertainty of the position values the second PPE state using the one or more predetermined values based, at least in part, on a determination that position variance values of the first PPE state exceed a threshold value.

25. An apparatus for handling a correction information source change for Global Navigation Satellite System (GNSS) positioning of a mobile device, the apparatus comprising:
means for obtaining first correction information from a first correction information source and second correction information from a second correction information source;
means for updating a Precise Positioning Engine (PPE) implemented at the mobile device to generate a first PPE state, wherein:
the first PPE state comprises a first set of position values, velocity values, and ambiguity values related to the position of the mobile device, and
the first PPE state is based at least in part on the first correction information and a set of measurements obtained from data received by a GNSS receiver of the mobile device;
means for modifying the first PPE state by initializing at least the ambiguity values of the first PPE state; and
means for updating the modified first PPE state to generate a second PPE state, wherein:
the second PPE state comprises a second set of position values, velocity values, and ambiguity values related to the position of the mobile device, and
the second PPE state is based at least in part on the second correction information and the set of measurements obtained from data received by the GNSS receiver of the mobile device.

26. The apparatus of claim 25, wherein the means for updating the modified first PPE state to generate the second PPE state comprises means for updating the modified first PPE state without a time update of the PPE.

27. The apparatus of claim 25, wherein the first correction information source comprises a physical Real-Time Kinematic (RTK) base station, a virtual RTK base station, or a Precise Point Positioning (PPP) source.

28. The apparatus of claim 27, wherein the second correction information source comprises a different type of correction information source than the first correction information source.

29. The apparatus of claim 27, wherein the second correction information source comprises a same type of correction information source as the first correction information source.

30. The apparatus of claim 25, wherein the means for modifying the first PPE state further comprises means for initializing the position values and the velocity values of the first PPE state.

31. The apparatus of claim 30, further comprising means for updating the second PPE state using the position values from the first PPE state.

32. The apparatus of claim 31, wherein the means for updating the second PPE state further comprises means for setting an uncertainty of the position values based on position variance values of the first PPE state.

33. The apparatus of claim 31, wherein the means for updating the second PPE state further comprises means for setting an uncertainty of the position values of the second PPE state using one or more predetermined values.

34. The apparatus of claim 33, wherein setting the uncertainty of the position values the second PPE state using the one or more predetermined values is based, at least in part, on a determination that position variance values of the first PPE state exceed a threshold value.

35. A non-transitory computer-readable medium storing instructions for handling a correction information source change for Global Navigation Satellite System (GNSS) positioning of a mobile device, the instructions comprising code for:
obtaining first correction information from a first correction information source and second correction information from a second correction information source;
updating a Precise Positioning Engine (PPE) implemented at the mobile device to generate a first PPE state, wherein:
the first PPE state comprises a first set of position values, velocity values, and ambiguity values related to the position of the mobile device, and
the first PPE state is based at least in part on the first correction information and a set of measurements obtained from data received by a GNSS receiver of the mobile device;
modifying the first PPE state by initializing at least the ambiguity values of the first PPE state; and
updating the modified first PPE state to generate a second PPE state, wherein:
the second PPE state comprises a second set of position values, velocity values, and ambiguity values related to the position of the mobile device, and
the second PPE state is based at least in part on the second correction information and the set of measurements obtained from data received by the GNSS receiver of the mobile device.

36. The computer-readable medium of claim 35, wherein the code for updating the modified first PPE state to generate the second PPE state comprises code for updating the modified first PPE state without a time update of the PPE.

37. The computer-readable medium of claim 35, wherein the code for modifying the first PPE state comprises code for initializing the position values and the velocity values of the first PPE state.

38. The computer-readable medium of claim 37, wherein the instructions further comprise code for updating the second PPE state using the position values from the first PPE state.

39. The computer-readable medium of claim 38, wherein the code for updating the second PPE state comprises code for setting an uncertainty of the position values based on position variance values of the first PPE state.

40. The computer-readable medium of claim 38, wherein the code for updating the second PPE state comprises code for setting an uncertainty of the position values of the second PPE state using one or more predetermined values.
